(19) United States
(12) Patent Application Publication
(10) Pub. No.: US 2019/0367029 A1
(43) Pub. Date: Dec. 5, 2019

(54) DYNAMIC SPEED CONTROLLER FOR VEHICLE

(71) Applicant: International Business Machines Corporation, Armonk, NY (US)

(72) Inventors: Marco Antonio MARTINEZ RUVALCABA, Jalisco (MX); Mauro MARZORATI, Lutz, FL (US)

(21) Appl. No.: 15/993,117

(22) Filed: May 30, 2018

(51) Int. Cl. B60W 30/18; B60W 50/00; B60W 50/08; B60W 50/12

(52) U.S. Cl. CPC B60W 30/18009; B60W 50/0098; B60W 50/082; B60W 50/087; B60W 2720/12; B60W 2540/26; B60W 2540/24; B60W 2550/00; B60W 2540/28; B60W 50/12

(57) ABSTRACT

A computer-implemented method is disclosed for controlling a speed of a vehicle. The method comprises acquiring information from a plurality of vehicle sensors, wherein the acquired information comprises image information acquired from one or more visual sensors, wherein the image information includes a driver of the vehicle. The method further comprises using one or more computer processors to perform image processing on the image information. The method further comprises dynamically determining an upper speed limit for the vehicle using the acquired information, wherein the upper speed limit is based in part on the image processing. The method further comprises receiving an acceleration input from a vehicle inceptor, and responsive to determining that application of the acceleration input would cause the speed of the vehicle to exceed the upper speed limit, transmitting a control signal to a vehicle actuator to avoid exceeding the upper speed limit.

### BACKGROUND

The present disclosure relates to techniques for controlling a speed of a vehicle, and more specifically, to dynamically determining an upper speed limit for the vehicle using a plurality of vehicle sensors.

A vehicle such as an automobile may be equipped with a speed limiter (also referred to as a governor) to limit a top speed of the vehicle. The speed limiter may be required by law in some jurisdictions, or may be enabled at the discretion of the vehicle manufacturer or the customer. Although the speed limiter may be configured to be overridden or disabled under some circumstances, the top speed of the speed limiter is typically statically set by the manufacturer, the customer, or the driver without consideration of dynamic factors during operation of the vehicle.

### SUMMARY

According to one embodiment, a computer-implemented method is disclosed for controlling a speed of a vehicle. The method comprises acquiring information from a plurality of vehicle sensors, wherein the acquired information comprises image information acquired from one or more visual sensors of the plurality of vehicle sensors, wherein the image information includes a driver of the vehicle. The method further comprises using one or more computer processors communicatively coupled with the one or more visual sensors, performing image processing on the image information. The method further comprises dynamically determining an upper speed limit for the vehicle using the acquired information, wherein the upper speed limit is based in part on the image processing. The method further comprises receiving an acceleration input from a vehicle inceptor, and responsive to determining that application of the acceleration input would cause the speed of the vehicle to exceed the upper speed limit, transmitting a control signal to a vehicle actuator to avoid exceeding the upper speed limit.

According to another embodiment, a computer program product is disclosed comprising a computer-readable storage medium having program instructions embodied therewith, the program instructions executable by one or more computer processors to perform an operation for controlling a speed of a vehicle. The operation comprises acquiring information from a plurality of vehicle sensors communicatively coupled with the one or more computer processors, wherein the acquired information comprises image information acquired from one or more visual sensors of the plurality of vehicle sensors, wherein the image information includes a driver of the vehicle. The operation further comprises performing image processing on the image information. The operation further comprises dynamically determining an upper speed limit for the vehicle using the acquired information, wherein the upper speed limit is based in part on the image processing. The operation further comprises receiving an acceleration input from a vehicle inceptor, and responsive to determining that application of the acceleration input would cause the speed of the vehicle to exceed the upper speed limit, transmitting a control signal to a vehicle actuator to avoid exceeding the upper speed limit.

According to another embodiment, a vehicle is disclosed comprising an inceptor, an actuator, and a plurality of sensors comprising one or more visual sensors. The vehicle further comprises one or more computer processors configured to acquire information from the plurality of sensors, wherein the acquired information comprises image information acquired from the one or more visual sensors, wherein the image information includes a driver of the vehicle. The one or more computer processors are further configured to perform image processing on the image information. The one or more computer processors are further configured to dynamically determine an upper speed limit for the vehicle using the acquired information, wherein the upper speed limit is based in part on the image processing. The one or more computer processors are further configured to receive an acceleration input from the inceptor, and responsive to determining that application of the acceleration input would cause the speed of the vehicle to exceed the upper speed limit, transmit a control signal to the actuator to avoid exceeding the upper speed limit.

### BRIEF DESCRIPTION OF THE SEVERAL VIEWS OF THE DRAWINGS

FIG. 1 is a block diagram illustrating an exemplary system for dynamically determining an upper speed limit for a vehicle, according to one or more embodiments.

FIG. 2 illustrates an exemplary passenger compartment of a vehicle, according to one or more embodiments.

FIG. 3 is a block diagram illustrating an exemplary speed limiter module for dynamically determining an upper speed limit for a vehicle, according to one or more embodiments.

FIG. 4 is a method for controlling a speed of a vehicle, according to one or more embodiments.

FIG. 5 illustrates an exemplary set of rules for a speed limiter module, according to one or more embodiments.

FIG. 6 illustrates exemplary combination functions for a set of rules, according to one or more embodiments.

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Embodiments discussed herein are directed to a method for controlling a speed of a vehicle. The method comprises acquiring information from a plurality of vehicle sensors, wherein the acquired information comprises image information acquired from one or more visual sensors of the plurality of vehicle sensors, wherein the image information includes a driver of the vehicle. The method further comprises performing image processing on the image information using one or more computer processors communicatively coupled with the one or more visual sensors. The method further comprises dynamically determining an upper speed limit for the vehicle using the acquired information, wherein the upper speed limit is based in part on the image processing. The method further comprises receiving an acceleration input from a vehicle inceptor, and responsive to determining that application of the acceleration input would cause the speed of the vehicle to exceed the upper speed limit, transmitting a control signal to a vehicle actuator to avoid exceeding the upper speed limit.

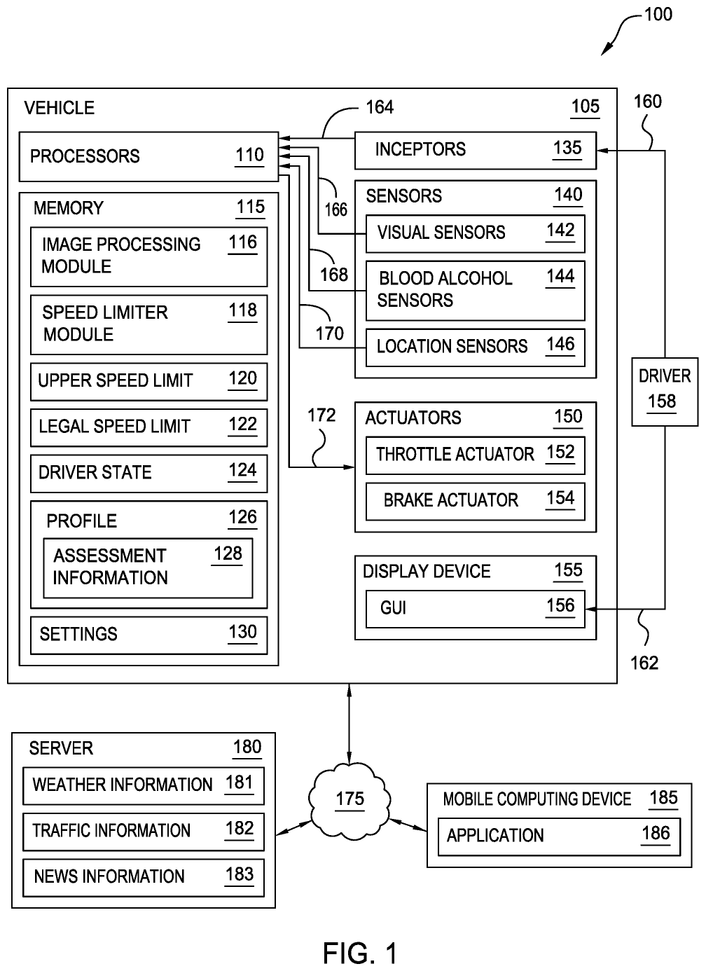

FIG. 1 is a block diagram illustrating an exemplary system 100 for dynamically determining an upper speed limit for a vehicle, according to one or more embodiments. The system 100 comprises a vehicle 105 having a controllable motive force, such as an internal combustion engine or electric motor. In some embodiments, the vehicle 105 comprises a passenger vehicle in any suitable configuration, such as a car, a truck, or a motorcycle configured for road transport. Other types of road transport vehicles, as well as vehicles using different modes of transport are also possible. Some non-limiting examples include aircraft, watercraft, and rail transport vehicles.

The vehicle 105 comprises one or more computer processors 110 and a memory 115. The one or more computer processors 110 and the memory 115 may be implemented in any suitable form, such as being included in a central vehicle controller, a separate controller communicatively coupled with the central vehicle controller, and so forth. The one or more computer processors 110 represent any number of processing elements that each can include any number of processing cores. Some non-limiting examples of the one or more computer processors 110 include a microprocessor, a digital signal processor (DSP), an application-specific integrated chip (ASIC), and a field programmable gate array (FPGA), or combinations thereof. The memory 115 may comprise volatile memory elements (such as random access memory), non-volatile memory elements (such as solid-state, magnetic, optical, or Flash-based storage), and combinations thereof. Moreover, the memory 115 may be distributed across different mediums (e.g., network storage or external hard drives).

The memory 115 may comprise a plurality of “modules” for performing various functions described herein. In one embodiment, each module includes program code that is executable by one or more of the computer processors 110. However, other embodiments may include modules that are partially or fully implemented in other hardware (i.e., circuitry) or firmware of the vehicle 105. As shown, the memory 115 comprises an image processing module 116 and a speed limiter module 118.

The image processing module 116 is configured to perform image processing on image information 166 received from one or more visual sensors 142 of the vehicle 105. In some embodiments, the image processing module 116 is configured to perform facial recognition of a driver 158 of the vehicle 105 according to any suitable techniques. Some non-limiting examples of facial recognition techniques include eigenfaces, Hidden Markov Models (HMM), or other geometric-based algorithms or template-based algorithms. In some embodiments, the facial recognition performed by the image processing module 116 is used to determine an identity of the driver 158. For example, the image processing module 116 may compare the image information 166 with a predefined image of the driver 158 stored in a predefined profile 126 associated with the driver 158.

In some embodiments, the image processing module 116 is configured to perform at least one of face tracking and head tracking to determine a driver state 124. The face tracking and/or head tracking may be performed during motive operation of the vehicle 105 (stated another way, while the driver 158 is driving the vehicle). The driver state 124 reflects one or more attributes of the driver 158 that relate to an ability of the driver 158 to safely operate the vehicle 105. In some embodiments, the image processing module 116 is configured to track facial features of the driver 158 and/or head movement of the driver 158 to perform one or more of the following: to identify an emotional mood of the driver 158 (e.g., upset or angry), to identify whether the driver 158 is distracted (e.g., looking away from the road to use a mobile phone, to talk to a passenger, etc.), and to identify whether the driver 158 is drowsy or otherwise impaired.

The speed limiter module 118 is configured to dynamically determine an upper speed limit 120 for the vehicle 105 based on information acquired from a plurality of sensors 140 of the vehicle 105. In some embodiments, the upper speed limit 120 may be dynamically updated by the speed limiter module 118 during motive operation of the vehicle 105.

The speed limiter module 118 may use raw sensor data and/or processed sensor data to determine the upper speed limit 120. In some embodiments, the upper speed limit 120 is based on the image processing performed by the image processing module 116, e.g., using the identity of the driver 158 and/or the driver state 124. In some embodiments, the upper speed limit 120 is based on a blood alcohol level 168 (e.g., a blood alcohol content (BAC)) acquired by one or more blood alcohol sensors 144. The one or more blood alcohol sensors 144 may comprise a breath-based system and/or a touch-based system (e.g., using near-infrared (NIR) tissue spectroscopy). In some embodiments, the upper speed limit 120 is based on location information 170 acquired by one or more location sensors 146. The one or more location sensors 146 may comprise a Global Positioning System (GPS) receiver configured to provide coordinates of the vehicle 105. The plurality of sensors 140 may include any other suitable type(s) of sensors.

The upper speed limit 120 may be further based on one or more other factors, e.g., using information stored in the memory 115 and/or information acquired via a network 175. The network 175 may include one or more networks of various types, including a local area or local access network (LAN), a general wide area network (WAN), and/or a public network (e.g., the Internet). In some embodiments, the network 175 comprises a decentralized, wireless ad hoc network that may support dynamic changes to the composition of the system 100.

As shown, the vehicle 105 is communicatively coupled with a server 180 and a mobile computing device 185 via the network 175. In some embodiments, the speed limiter module 118 may determine the upper speed limit 120 based on one or more of weather information 181, traffic information 182, and news information 183 acquired via the network 175. In one example, the upper speed limit 120 may be set to a lesser value when the weather information 181 indicates the presence of precipitation such as rain or snow, when compared with sunny and/or dry conditions. In another example, the upper speed limit 120 may be set to a lesser value when the traffic information 182 indicates denser automotive traffic and/or an upcoming traffic event. In another example, the upper speed limit 120 may be set to a lesser value when the news information 183 indicates an event in which a greater number of people, animals, etc. may be expected on or along the road.

In some cases, the information acquired by the speed limiter module 118 may be based on the data acquired by the plurality of sensors 140. For example, the location information 170 may be transmitted over the network 175 and a legal speed limit 122 retrieved from a server 180 based on the location information 170.

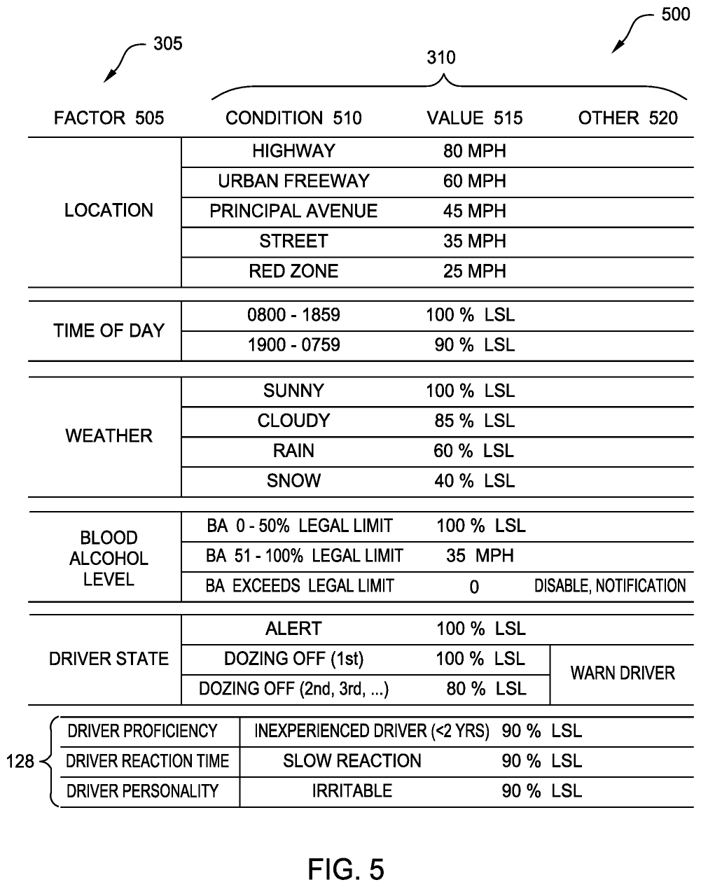

In some embodiments, the predefined profile 126 associated with the driver 158 is stored in the memory 115. The predefined profile 126 may include information reflecting one or more attributes of the driver 158 that relate to an ability of the driver 158 to safely operate the vehicle 105. In some embodiments, the predefined profile 126 comprises assessment information 128 reflecting a driving performance of the driver 158. For example, the memory 115 may comprise an assessment module (not shown) configured to test a reaction time and/or a judgment of the driver 158 based on input information 164 received from a plurality of inceptors 135. In some cases, the assessment module comprises a predefined series of tests in which the driver 158 is prompted using one or more output devices (e.g., a display device 155), and responds using the plurality of inceptors 135. In some cases, the assessment module may be based on historical driving information for the driver 158. In some embodiments, the assessment module is configured to use suitable machine learning techniques when determining the assessment information 128, which may be supervised or unsupervised. For example, the assessment module may use an artificial neural network that receives information from the plurality of inceptors 135, the historical driving information for the driver 158, physical attributes for the driver 158, etc. as inputs, and that generates the assessment information 128 as an output. In one embodiment, the assessment module may train the artificial neural network using the predefined profile 126, e.g., historical driving information for the driver 158 relative to different zones or speed limits. The test data for the artificial neural network may comprise the location information 170, and the legal speed limit 122 and/or the type of road surface. As will be discussed with respect to FIG. 5, additional inputs and or different types of inputs may input as test data for the artificial neural network. Weights or other parameters of the artificial neural network may be dynamically adapted, e.g., using information acquired via the network 175.

The plurality of inceptors 135 are configured to receive inputs 160 from the driver 158, and to output the input information 164. The plurality of inceptors 135 may have any suitable implementation, such as a steering wheel, an accelerator pedal, a brake pedal, a joystick, a throttle lever, and so forth. In some embodiments, the inceptors 135 are mechanically linked to one or more actuators 150 of the vehicle 105. In other embodiments, the vehicle 105 is “drive-by-wire” and one or more of the inceptors 135 are mechanically decoupled from the one or more actuators 150. In some embodiments, the one or more computer processors 110 are configured to transmit control signals 172 to the one or more actuators 150 based on the determined upper speed limit 120 determined by the speed limiter module 118.

In some embodiments, the speed limiter module 118 is configured to use suitable machine learning techniques when determining the upper speed limit 120, which may be supervised or unsupervised. For example, the speed limiter module 118 may use an artificial neural network that receives information from the plurality of sensors 140, the legal speed limit 122, the driver state 124, etc. as inputs, and that generates the upper speed limit 120 as an output.

In some embodiments, the memory 115 may comprise one or more settings 130 used to configure the operation of the speed limiter module 118. For example, the settings 130 may be used to adjust weights of the neural network, to include or exclude particular inputs, and so forth. In another example, the settings 130 may be used to enable or disable the upper speed limit 120. In yet another example, the settings 130 may be used to manually override the upper speed limit 120 calculated by the speed limiter module 118 with a more restrictive speed limit.

In some embodiments, the settings 130 may be provided via input to the one or more computer processors 110. In one example, the input for the settings 130 may be provided via a graphical user interface (GUI) 156 displayed on a display device 155 of the vehicle. In another example, the input for the settings 130 may be provided via an application 186 executed by a mobile computing device 185. In some embodiments, the settings 130 may have restricted access (e.g., protected by a password, passcode, biometric information, etc.). For example, access may be restricted to prevent a target driver (e.g., a relatively “risky” driver such as a teenager) from intentionally bypassing the restrictions of the speed limiter module 118 (e.g., disabling or overriding the upper speed limit 120).

The display device 155 may have any suitable implementation. Some non-limiting examples of the display device 155 include light emitting diode (LED), organic LED (OLED), liquid crystal display (LCD) including a super-twisted nematic (STN) LCD, plasma, electroluminescence (EL), electronic ink (e-ink), or other display technology. In some embodiments, the display device 155 is integrated with a portion of the vehicle 105, such as being included a dashboard of the vehicle 105. In some embodiments, the display device 155 may be integrated with an input device such as a capacitive or resistive touchscreen, allowing the driver 158 or other passengers of the vehicle 105 to provide inputs 162 to the one or more computer processors 110.

The mobile computing device 185 may have any suitable implementation, such a as a smartphone or tablet device. In some cases, the mobile computing device 185 may be operated by the driver 158. In other cases, the mobile computing device 185 may be operated by another person (e.g., a parent, an employer) seeking to control a speed of the driver 158.

In some embodiments, the driver 158 may request that the upper speed limit 120 be disabled or overridden. For example, the driver 158 may provide an indication of an emergency situation via the GUI 156. In such an event, the one or more computer processors 110 may communicate the request via the network 175 to the mobile computing device 185. The mobile computing device 185 may be used to provide an authorization via the network 175. The speed limiter module 118 may disable or relax the upper speed limit 120 responsive to the authorization. In some embodiments, the speed limiter module 118 may disable or relax the upper speed limit 120 temporarily, such as for a predetermined amount of time (e.g., 20 minutes), for the duration of the current trip (e.g., until the vehicle 105 is parked or the ignition turned off), and so forth.

As discussed above, the one or more computer processors 110 may be configured to transmit control signals 172 to the one or more actuators 150 based on the determined upper speed limit 120 determined by the speed limiter module 118. The one or more actuators 150 may have any suitable implementation. As shown, the actuators 150 comprise a throttle actuator 152 (e.g., an electric motor) and a brake actuator 154 (e.g., used in an electric, hydraulic, or electric-over-hydraulic brake system).

In some embodiments, the one or more computer processors 110 receive an acceleration input from one of the inceptors 135. For example, the driver 158 may depress an accelerator pedal, manipulate a throttle lever, press a button to set a new speed set point, and so forth. The speed limiter module 118 may determine whether application of the acceleration input would cause the speed of the vehicle 105 to exceed the upper speed limit 120. In some embodiments, responsive to determining that application of the acceleration input would exceed the upper speed limit 120, the one or more processors 110 may transmit control signals 172 to the one or more actuators. In some embodiments, transmitting control signals 172 to the one or more actuators 150 comprises at least one of: transmitting the control signals 172 to the throttle actuator 152, wherein a contribution of the acceleration input is ignored or modified. In some embodiment, transmitting the control signals 172 to the brake actuator 154 to mitigate the application of the acceleration input.

In some embodiments, at least one of the inceptors 135 may be mechanically linked to at least one of the actuators 150. For example, an accelerator pedal of the vehicle 105 may be mechanically linked to a throttle actuator. In such a cases, the one or more actuators 150 may comprise an actuator configured to mechanically decouple an inceptor 135 from an actuator 150 responsive to determining that application of the acceleration input would exceed the upper speed limit 120, an actuator configured to resist the motion of the inceptor 135, and so forth.

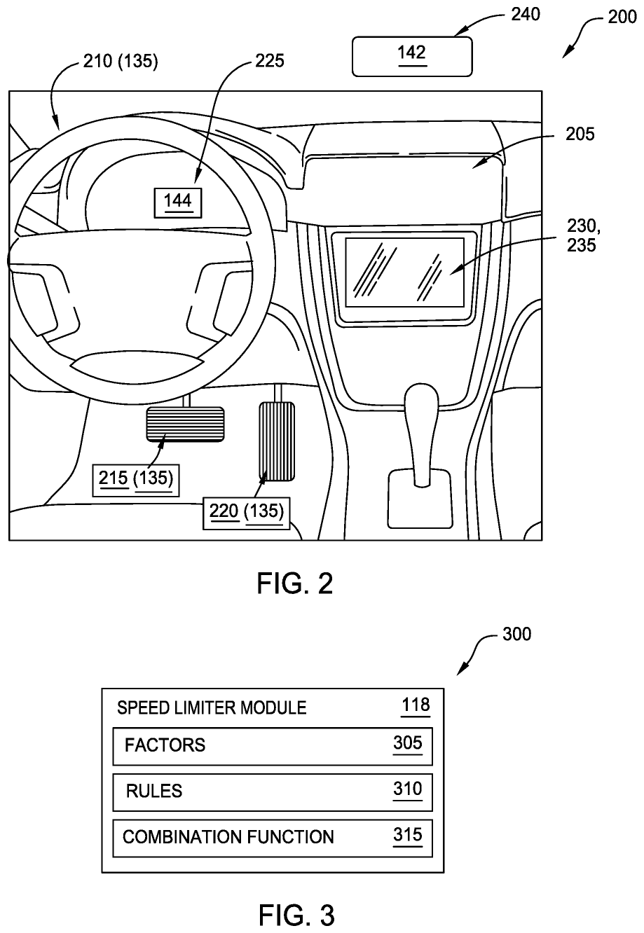

FIG. 2 illustrates an exemplary passenger compartment 200 of a vehicle, according to one or more embodiments. The features discussed with respect to FIG. 2 may be used in conjunction with other embodiments discussed herein, such as the vehicle 105 of FIG. 1.

The passenger compartment 200 comprises a dashboard 205, a steering wheel 210 (one example of an inceptor 135), a brake pedal 215 (another example of an inceptor 135), and an accelerator pedal 220 (another example of an inceptor 135). The passenger compartment further comprises a rear-view mirror 240. One or more display devices 225, 230 (which may be examples of the display device 155) may be integrated with the dashboard 205. As shown, the dashboard 205 comprises a first display device 225 arranged near the steering wheel 210, and a second display device 230 arranged in a center console portion. In some embodiments, the first display device 225 comprises a physical or digital instrument cluster that displays various measurements and/or indicators of the operation of the vehicle. In some embodiments, the second display device 230 comprises a navigation and/or entertainment system of the vehicle.

The second display device 230 may display a GUI 235 configured to present and/or receive information to the driver of the vehicle. For example, the GUI 235 may represent one example of the GUI 156 of FIG. 1, and the driver may interact with the GUI 235 to, e.g., request that the upper speed limit be disabled. In other embodiments, the first display device 225 may additionally or alternately display the GUI 235.

The blood alcohol sensor 144 may be arranged near the steering wheel 210 and/or the first display device 225. In some embodiments, the blood alcohol sensor 144 comprises a breath-based system configured to measure alcohol content in the ambient air, which is indicative of the BAC of the driver. In other embodiments, the blood alcohol sensor 144 comprises a touch-based system (e.g., using near-infrared (NIR) tissue spectroscopy), which may be integrated in the steering wheel 210.

The visual sensor 142 is configured to acquire image information that includes the driver. The visual sensor 142 may have any suitable implementation, such as a camera sensing visible light wavelengths, a camera sensing infrared wavelengths, and so forth. In some embodiments, the visual sensor 142 is integrated in, or arranged near the rear-view mirror 240. In other embodiments, the visual sensor 142 may be included in any other suitable portion of the passenger compartment 200.

FIG. 3 is a block diagram 300 illustrating an exemplary speed limiter module 118 for dynamically determining an upper speed limit for a vehicle, according to one or more embodiments. The features of the block diagram 300 may be used in conjunction with other embodiments, such as the vehicle 105 of FIG. 1.

The speed limiter module 118 is configured to generate an upper speed limit using one or more factors 305, one or more rules 310, and/or a combination function 315. The one or more factors 305 may comprise one or more “intrinsic” factors (e.g., raw and/or processed data acquired by vehicle sensors, data stored in a memory of the vehicle), and/or one or more “extrinsic” factors (e.g., raw and/or processed data acquired via a network).

Each of the one or more rules 310 are related to one or more of the factors 305. In some embodiments, the one or more rules 310 map a particular value (or range of values) of one or more of the factors 305 (whether separately or in combination) to a value for an upper speed limit. The value for the upper speed limit may be embodied in any suitable form, such as an absolute speed value, a relative speed value (e.g., a percentage of a reference speed, a difference from a reference speed), a safe driving score used to calculate the upper speed limit. In some embodiments, the one or more rules 310 may specify one or more other actions to be performed by the speed limiter module or another portion of controller circuitry of the vehicle.

Refer also to FIG. 5, which illustrates an exemplary set of rules for a speed limiter module, according to one or more embodiments. The features of the diagram 500 may be used in conjunction with other embodiments, such as implemented in the speed limiter module 118 of FIGS. 1 and 3.

The diagram 500 includes a left-most column illustrating different factors 505 (examples of the one or more factors 305), a next column illustrating different conditions 510, a next column illustrating different values 515 of an upper speed limit, and a right-most column illustrating other actions 520 to be performed. Collectively, the conditions 510, values 515, and other actions 520 provide different examples of the one or more rules 310.

In the diagram 500, a first factor 505 (location) corresponds to five different conditions 510 representing different types of roads: highway, urban freeway, principal avenue, street, and red zone. As discussed above, the location of the vehicle may be determined using, e.g., a location sensor of the vehicle. The “highway” condition corresponds to a value 515 of 80 miles per hour (MPH), the “urban freeway” condition corresponds to a value of 60 MPH, the “principal avenue” condition corresponds to a value of 45 MPH, the “street” condition corresponds to a value of 35 MPH, and the “red zone” condition corresponds to a value of 25 MPH.

A second factor 505 (time of day) corresponds to two different conditions 510 representing different times of day, which may be correlated with different road temperatures affecting traction of the vehicle. The time of day may be determined using, e.g., an internal time of the vehicle, a time accessed via a network, and so forth. The “0800-1859” condition corresponds to a value 515 of 100% of the legal speed limit (LSL), and the “1900-0759” condition corresponds to a value of 90% of the LSL.

A third factor 505 (weather) corresponds to four different conditions 510 representing different weather conditions that can affect traction of the vehicle. The weather may be determined using, e.g., one or more vehicle sensors, weather information accessed via a network, and so forth. The “sunny” condition corresponds to a value 515 of 100% of the LSL, the “cloudy” condition corresponds to a value of 85% of the LSL, the “rain” condition corresponds to a value of 60% of the LSL, and the “snow” condition corresponds to a value of 40% of the LSL.

A fourth factor 505 (blood alcohol level) corresponds to three different conditions 510 representing different blood alcohol levels that can affect the driver's ability to operate the vehicle safely. The blood alcohol level may be determined using blood alcohol sensors of the vehicle. The “0-50% legal limit” condition corresponds to a value 515 of 100% of the LSL, the “51-100% legal limit” condition corresponds to a value of 35 MPH, and the “exceeds legal limit” condition corresponds to a value of zero. The “exceeds legal limit” condition may also correspond to one or more other actions 520, such as disabling the vehicle, transmitting a notification over a network, and so forth.

A fifth factor 505 (driver state) corresponds to three different conditions 510 representing different driver states that can affect the driver's ability to operate the vehicle safely. The driver state may be determined using image information acquired by one or more visual sensors of the vehicle. For example, face tracking and/or head tracking may be performed using the image information.

The “alert” condition corresponds to a value 515 of 100% of the LSL. The “dozing off (1st)” condition represents a first instance of detecting that the driver is drowsy (e.g., closing the eyes for a period of time longer than a blink). The “dozing off (1st)” condition corresponds to a value of 100% of the LSL, as well as the other action 520 of transmitting a warning to the driver (e.g., an audible or haptic output intended to return the driver to the alert condition). The “dozing off (2d, 3d, . . . )” condition represents subsequent instances of detecting that the driver is drowsy, and corresponds to a value of 80% of the LSL.

While the discussion of the fifth factor 505 focuses specifically on a drowsiness of the driver, alternate embodiments may additionally or alternately consider an emotional mood of the driver, whether the driver is distracted, and so forth.

A sixth factor 505 relates to assessment information 128 associated with the driver. For example, an assessment module may be configured to test a reaction time and/or a judgment of the driver based on input information received from vehicle inceptors. A first subfactor (driver proficiency) corresponds to a condition 510 of an “inexperienced driver (<2 yrs)” representing the driver's ability to operate the vehicle safely. The “inexperienced driver (<2 yrs)” condition corresponds to a value of 90% of the LSL. A second subfactor (driver reaction time) corresponds to a condition of “slow reaction” representing the driver's ability to operate the vehicle safely. The “inexperienced driver (<2 yrs)” condition corresponds to a value of 90% of the LSL. A third subfactor (driver personality) corresponds to a condition of “irritable” representing the driver's ability to operate the vehicle safely. The “irritable” condition corresponds to a value of 90% of the LSL.

The combination of the factors 505 discussed above represent one possibility of the operation of a speed limiter module. However, the person of ordinary skill will understand that any suitable alternate factors 505 and/or combinations are also possible. Further, while a static configuration of the rules 310 is illustrated in the diagram 500, alternate embodiments may include one or more rules 310 that are dynamically updated. For example, machine learning techniques may be used to determine and/or adjust different conditions 510, values 515, and/or other actions 520 based on inputs from the driver.

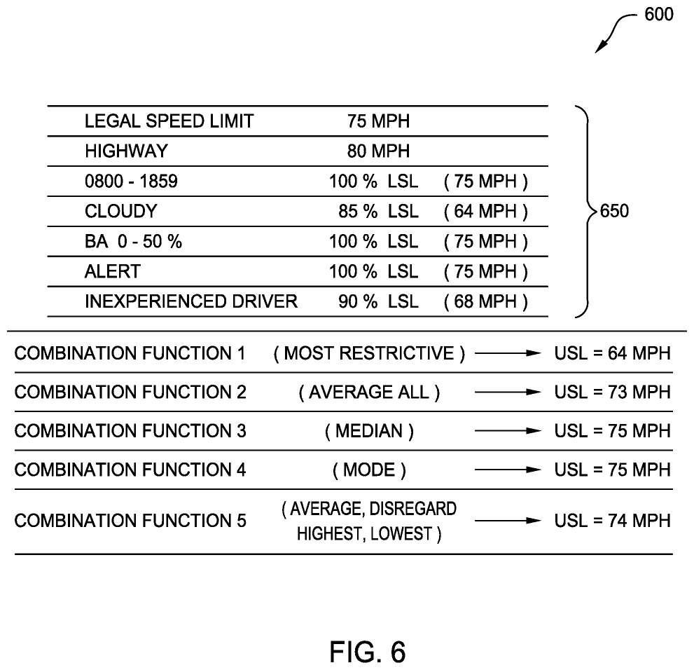

Returning to FIG. 3, a combination function 315 may be used by the speed limiter module 118 to combine the different values 515 and produce the upper speed limit. The combination function 315 may include any suitable arithmetic and/or logical functions. FIG. 6 is a diagram 600 illustrating exemplary combination functions for a set of rules, according to one or more embodiments.

The diagram 600 includes a set 650 of rules imposed by the speed limiter module. In the set 650, the LSL is 75 MPH. The location factor indicates a “highway” condition corresponding to 80 MPH. The time of day factor indication a “0800-1859” condition corresponding to 100% LSL (75 MPH in this case). The weather factor indicates a “cloudy” condition corresponding to 85% LSL (64 MPH). The blood alcohol level factor indicates a “0-50%” condition corresponding to 100% LSL (75 MPH). The driver state factor indicates an “alert” condition corresponding to 100% LSL (75 MPH). The driver assessment factor indicates an “inexperienced driver” condition corresponding to 90% LSL (68 MPH).

A first combination function (combination function 1) selects a most restrictive speed value of the set 650 of rules as the upper speed limit (USL), which is 64 MPH in this case (corresponding to the weather factor). A second combination function (combination function 2) selects an average of all the speed values of the set 650 of rules as the USL, which is 73 MPH in this case. A third combination function (combination function 3) selects a median value of the set 650 of rules as the USL, which is 75 MPH in this case. A fourth combination function (combination function 4) selects a mode value of the set 650 of rules as the USL, which is 75 MPH in this case. A fifth combination function (combination function 5) disregards a highest value and a lowest value of the set 650 of rules, and selects an average of the remaining values as the USL, which is 74 MPH in this case.

The combination functions discussed above represent possibilities of the operation of a speed limiter module. However, the person of ordinary skill will understand that any suitable alternate combination function is also possible. Further, while a static configuration of the combination function is illustrated in the diagram 600, alternate embodiments may include a combination function that is dynamically updated.

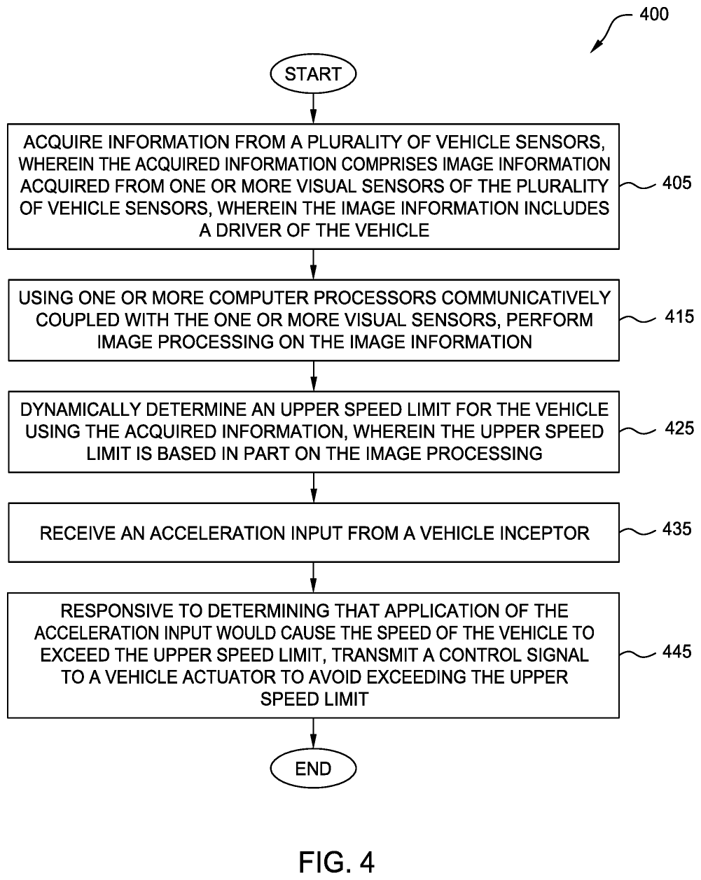

Next, FIG. 4 is a method 400 for controlling a speed of a vehicle, according to one or more embodiments. The method 400 may be used in conjunction with other embodiments, such as performed by the one or more computer processors 110 of FIG. 1.

The method 400 begins at block 405, where the one or more computer processors acquire information from a plurality of vehicle sensors. The acquired information comprises image information acquired from one or more visual sensors of the plurality of vehicle sensors. The image information includes a driver of the vehicle.

At block 415, the one or more computer processors perform image processing on the image information. At block 425, the one or more computer processors dynamically determine an upper speed limit for the vehicle using the acquired information. The upper speed limit is based in part on the image processing. In some embodiments, the image processing comprises facial recognition to determine an identity of the driver, and the identity may be used to access a predefined profile including information reflecting one or more attributes of the driver relating to an ability of the driver to safely operate the vehicle. In some embodiments, the predefined profile comprises assessment information reflecting a driving performance of the driver.

In some embodiments, the image processing comprises at least one of face tracking and head tracking to determine a driver state. The face tracking and/or head tracking may be performed during motive operation of the vehicle. The face tracking and/or head tracking may be used to identify an emotional mood of the driver, to identify whether the driver is distracted, and to identify whether the driver is drowsy or otherwise impaired.

At block 435, the one or more computer processors receive an acceleration input from a vehicle inceptor. The acceleration input may comprise the driver depressing an accelerator pedal, manipulating a throttle lever, pressing a button to set a new speed set point, and so forth. At block 445, the one or more computer processors transmit, responsive to determining that application of the acceleration input would cause the speed of the vehicle to exceed the upper speed limit, transmit a control signal to a vehicle actuator to avoid exceeding the upper speed limit. In some embodiments, the control signal is transmitted to a throttle actuator, wherein a contribution of the acceleration input is ignored or modified. In some embodiments, the control signal is transmitted to a brake actuator to mitigate the application of the acceleration input. In some embodiments, the control signal is transmitted to an actuator that mechanically decouples the inceptor from the actuator. In some embodiments, the control signal is transmitted to an actuator that resists the motion of the inceptor. The method 400 ends following completion of block 445.

In another exemplary implementation of the speed limiter module 118 of FIG. 1, the speed limiter module 118 receives a plurality of primary inputs comprising: vehicle speed, a speed limiter condition (e.g., corresponding to one or more rules of the speed limiter module 118), a predefined profile associated with the driver, mood information, location information, and a blood alcohol level. The speed limiter module 118 may further receive one or more secondary inputs comprising weather information, time of day information, and/or traffic information. The speed limiter module 118 may further received one or more tertiary inputs comprising road condition or status information, and/or news information.

The speed limiter module 118 may determine an upper speed limit for the vehicle, and may generate one or more outputs based on the upper speed limit. In some embodiments, a control signal is transmitted to a throttle actuator of the vehicle. In some embodiments, a control signal is transmitted to a brake actuator of the vehicle. In some embodiments, a visual, audio, or haptic output is provided to the driver. In some embodiments, a control signal is transmitted to a cruise control system of the vehicle.

In an exemplary operation, the vehicle is turned on and image information including the driver is acquired. A controller of the vehicle (which may include the speed limiter module 118) determines whether the driver is associated with a predefined profile. If the driver is not associated with a profile, the speed limiter module 118 may be disabled. If the driver is associated with a profile, the controller determines whether a speed limiter condition is enabled. In one example, the speed limiter condition comprises a legal speed limit. In another example, the speed limiter condition comprises an upper speed limit different than the legal speed limit (e.g., a percentage of the legal speed limit). The driver may operate the vehicle less than the upper speed limit normally (i.e., without restriction), and the operation of the vehicle may be restricted when the controller determines that the upper speed limit would be exceeded. In some embodiments, another user having sufficient privileges (e.g., a parent of a teenage driver) may be able to override or disable the speed limiter condition. The controller may further be able to share information in real time with a GUI while the vehicle is being operated.

In some embodiments, when the driver operates the vehicle such that the upper speed limit is reached, the controller may disable the signal to the throttle actuator and/or active a cruise control system to maintain the vehicle speed at the upper speed limit. The controller may permit a predefined variance from the upper speed limit (e.g., 2% of the upper speed limit). In such a case, if the vehicle speed exceeds the predefined variance, the controller may transmit a signal to a brake actuator to return the vehicle speed to within the predefined variance. When the driver lifts from the accelerator pedal, such that the vehicle may decelerate, the cruise control may be disabled.

The upper speed limit determined by the speed limiter module 118 may be based on one or more of the primary inputs. In one example, the upper speed limit is based on a driver profile (e.g., a set of conditions specified using a GUI). The driver profile may include one or more conditions specifying whether the driver needs to have the upper speed limit enabled, whether the upper speed limit should be constant or dynamic, and whether, if the upper speed limit is dynamic, the upper speed limit should be the same as the legal speed limit or a slower speed.

In one example, the upper speed limit is based on a driver state. The driver state may be determined using a visual sensor (e.g., on the rear-view mirror) and image processing of the controller. The image processing may identify gestures and/or a posture of the driver to determine whether the driver is capable of safely driving the vehicle. If the driver is determined to be able to drive safely, then the upper speed limit for that user may be set. If a change in the driver state is determined (e.g., the driver becomes drowsy), the controller may provide a visual, audio, or haptic output to alert the driver. If the controller determines that the driver has a reduced capability for driving safely but is still able to safely drive the vehicle, the controller may reduce the upper speed limit for the driver (e.g., 60% of the “normal” upper speed limit for that driver). If the controller determines that the driver is no longer able to safely drive the vehicle, the controller may set an alarm and may (gradually) reduce the upper speed limit (and/or the speed of the vehicle). In some embodiments, the controller may stop the vehicle (reducing the upper speed limit to zero). The controller may further transmit a notification indicating the condition of the driver. Further, if the controller determines prior to driving the vehicle that the driver is not capable of safely driving the vehicle, the controller may prevent signals from being transmitted to a throttle actuator to prevent driving, and may further transmit a notification indicating the condition of the driver.

In one example, the upper speed limit is based on location information associated with the vehicle. A location signal may be provided by a GPS receiver, and a legal speed limit of the location may be determined, e.g., using an Internet of Things (IoT) connectivity of the vehicle. If the legal speed limit cannot be determined (e.g., the vehicle has lost connectivity, or the street doesn't have a posted speed limit), the controller may perform one of disabling the speed limiter module, and setting an upper speed limit for such a case.

In one example, the upper speed limit is based on blood alcohol information associated with the driver. For example, a blood alcohol sensor may be arranged behind the steering wheel of the vehicle. If the controller detects that the driver has a zero blood alcohol level, the driver may be permitted to drive at the upper speed limit. If the controller detects that the blood alcohol level is the same or less than the legal limit for the location of the vehicle, the controller may adapt the upper speed limit accordingly. For example, the controller may reduce the upper speed limit by x %, where the upper speed limit and/or the value of x are set using the GUI. However, if the controller detects that the blood alcohol level exceeds the legal limit, the controller may disable the vehicle and may further transmit a notification indicating the condition of the driver.

The upper speed limit determined by the speed limiter module 118 may be based on one or more of the secondary inputs. In one example, the upper speed limit is based on weather information. If the controller determines sub-optimal driving conditions (such as snow, rain, fog), the upper speed limit may be decreased (e.g., by 25%). In another example, the upper speed limit is based on time of day information. If the controller determines that the vehicle is driving past a school during school hours, the upper speed limit may be decreased. In another example, the upper speed limit is based on traffic information. If the controller determines that there is construction, a car accident, a public protest, etc. near the location of the vehicle (or along a planned route of the vehicle), the upper speed limit may be decreased. The traffic information may be supplemented by news analytics information.

The upper speed limit determined by the speed limiter module 118 may be based on one or more of the tertiary inputs. For example, the controller may communicate via an external network to determine road status or any other suitable reason to reduce speed for security reasons, such as incidents, road damage, degraded street lighting, etc. In some cases, the controller may be configured to access web information with analytics services.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to embodiments of the present invention, other and further embodiments of the invention may be devised without departing from the basic scope thereof, and the scope thereof is determined by the claims that follow.

What is claimed is:

1. A computer-implemented method for controlling a speed of a vehicle, the method comprising:
acquiring information from a plurality of vehicle sensors, wherein the acquired information comprises image information acquired from one or more visual sensors of the plurality of vehicle sensors, wherein the image information includes a driver of the vehicle;
using one or more computer processors communicatively coupled with the one or more visual sensors, performing image processing on the image information;
dynamically determining an upper speed limit for the vehicle using the acquired information, wherein the upper speed limit is based in part on the image processing;
receiving an acceleration input from a vehicle inceptor; and
responsive to determining that application of the acceleration input would cause the speed of the vehicle to exceed the upper speed limit, transmitting a control signal to a vehicle actuator to avoid exceeding the upper speed limit.

2. The computer-implemented method of claim 1, wherein performing image processing on the image information comprises:
performing at least one of face tracking and head tracking to determine a driver state,
wherein the upper speed limit is based in part on the driver state.

3. The computer-implemented method of claim 2, wherein acquiring the information from the plurality of vehicle sensors occurs during motive operation of the vehicle.

4. The computer-implemented method of claim 1, wherein performing the image processing on the image information comprises:
performing facial recognition to determine an identity of the driver, the method further comprising:
accessing a predefined profile corresponding to the identity, wherein the predefined profile comprises assessment information for the driver,
wherein the upper speed limit is based in part on the assessment information.

5. The computer-implemented method of claim 1, wherein transmitting the control signal to the vehicle actuator comprises at least one of:
transmitting the control signal to a throttle actuator, wherein a contribution of the acceleration input is ignored or modified; and
transmitting the control signal to a brake actuator to mitigate application of the acceleration input.

6. The computer-implemented method of claim 1, wherein the plurality of vehicle sensors further comprises a blood alcohol sensor and a location sensor, the method further comprising:
determining a blood alcohol level of the driver using the blood alcohol sensor;
determining a location of the vehicle using the location sensor; and
determining a legal speed limit for the location,
wherein the dynamically determining the upper speed limit is further based on the blood alcohol level and on the legal speed limit.

7. The computer-implemented method of claim 1, further comprising:
receiving an input from the driver at a graphical user interface displayed using a display device of the vehicle;
transmitting, responsive to the input, a request that the upper speed limit be disabled; and
responsive to receiving an approval of the request, disabling the upper speed limit.

8. A computer program product comprising a computer-readable storage medium having program instructions embodied therewith, the program instructions executable by one or more computer processors to perform an operation for controlling a speed of a vehicle, the operation comprising:
acquiring information from a plurality of vehicle sensors communicatively coupled with the one or more computer processors, wherein the acquired information comprises image information acquired from one or more visual sensors of the plurality of vehicle sensors, wherein the image information includes a driver of the vehicle;
performing image processing on the image information;
dynamically determining an upper speed limit for the vehicle using the acquired information, wherein the upper speed limit is based in part on the image processing;
receiving an acceleration input from a vehicle inceptor; and
responsive to determining that application of the acceleration input would cause the speed of the vehicle to exceed the upper speed limit, transmitting a control signal to a vehicle actuator to avoid exceeding the upper speed limit.

9. The computer program product of claim 8, wherein performing image processing on the image information comprises:
performing at least one of face tracking and head tracking to determine a driver state,
wherein the upper speed limit is based in part on the driver state.

10. The computer program product of claim 9, wherein acquiring the information from the plurality of vehicle sensors occurs during motive operation of the vehicle.

11. The computer program product of claim 8, wherein performing the image processing on the image information comprises:
performing facial recognition to determine an identity of the driver, the operation further comprising:
accessing a predefined profile corresponding to the identity, wherein the predefined profile comprises assessment information for the driver,
wherein the upper speed limit is based in part on the assessment information.

12. The computer program product of claim 8, wherein transmitting the control signal to the vehicle actuator comprises at least one of:
transmitting the control signal to a throttle actuator, wherein a contribution of the acceleration input is ignored or modified; and
transmitting the control signal to a brake actuator to mitigate application of the acceleration input.

13. The computer program product of claim 8, wherein the plurality of vehicle sensors further comprises a blood alcohol sensor and a location sensor, the operation further comprising:
determining a blood alcohol level of the driver using the blood alcohol sensor;
determining a location of the vehicle using the location sensor; and
determining a legal speed limit for the location,
wherein the dynamically determining the upper speed limit is further based on the blood alcohol level and on the legal speed limit.

14. The computer program product of claim 8, the operation further comprising:
receiving an input from the driver at a graphical user interface displayed using a display device of the vehicle;
transmitting, responsive to the input, a request that the upper speed limit be disabled; and
responsive to receiving an approval of the request, disabling the upper speed limit.

15. A vehicle comprising:
an inceptor;
an actuator;
a plurality of sensors comprising one or more visual sensors; and
one or more computer processors configured to:
acquire information from the plurality of sensors, wherein the acquired information comprises image information acquired from the one or more visual sensors, wherein the image information includes a driver of the vehicle;
perform image processing on the image information;
dynamically determine an upper speed limit for the vehicle using the acquired information, wherein the upper speed limit is based in part on the image processing;
receive an acceleration input from the inceptor; and
responsive to determining that application of the acceleration input would cause the speed of the vehicle to exceed the upper speed limit, transmit a control signal to the actuator to avoid exceeding the upper speed limit.

16. The vehicle of claim 15, wherein receiving the acceleration input from the inceptor comprises the driver depressing an accelerator pedal.

17. The vehicle of claim 15, wherein performing image processing on the image information comprises:
performing at least one of face tracking and head tracking to determine a driver state,
wherein the upper speed limit is based in part on the driver state.

18. The vehicle of claim 17, wherein acquiring the information from the plurality of sensors occurs during motive operation of the vehicle.

19. The vehicle of claim 15, wherein performing the image processing on the image information comprises:
performing facial recognition to determine an identity of the driver, the method further comprising:
accessing a predefined profile corresponding to the identity, wherein the predefined profile comprises assessment information for the driver,
wherein the upper speed limit is based in part on the assessment information.

20. The vehicle of claim 15, wherein transmitting the control signal to the actuator comprises at least one of:
transmitting the control signal to a throttle actuator, wherein a contribution of the acceleration input is ignored or modified; and
transmitting the control signal to a brake actuator to mitigate application of the acceleration input.
